(19) United States
(12) Patent Application Publication
(10) Pub. No.: US 2026/0194024 A1
(43) Pub. Date: Jul. 9, 2026

(54) INTERNAL COMBUSTION ENGINE

(71) Applicant: TOYOTA JIDOSHA KABUSHIKI KAISHA, Toyota-shi (JP)

(72) Inventor: Toshihiro ISHIKAWA, Toyota-shi (JP)

(73) Assignee: TOYOTA JIDOSHA KABUSHIKI KAISHA, Toyota-shi (JP)

(21) Appl. No.: 19/408,731

(22) Filed: Dec. 4, 2025

(30) Foreign Application Priority Data
Jan. 8, 2025 (JP) 2025-002897

(51) Int. Cl. F02D 41/14; F02D 41/36; F02D 41/38

(52) U.S. Cl. CPC F02D 41/1454; F02D 41/1497; F02D 41/36; F02D 41/38; F02D 2041/389; F02D 2200/04

(57) ABSTRACT

An internal combustion engine includes a first injection valve configured to inject a fuel into an intake port of the internal combustion engine, a second injection valve configured to inject a fuel into a cylinder of the internal combustion engine, and a controller configured to control an in-cylinder injection ratio, which is a ratio of an in-cylinder injection amount to a total amount of a port injection amount and the in-cylinder injection amount, the port injection amount being a fuel injection amount of the first injection valve and the in-cylinder injection amount being a fuel injection amount of the second injection valve. The controller of the internal combustion engine sets an in-cylinder injection ratio in an operation region that is predetermined to 100% in accordance with detection of accumulation of a deposit in an intake port.

### CROSS-REFERENCE TO RELATED APPLICATION

This application claims priority to Japanese Patent Application No. 2025-002897 filed on January 8, 2025. The disclosure of the above-identified application, including the specification, drawings, and claims, is incorporated by reference herein in its entirety.

### BACKGROUND

### 1. Technical Field

The present disclosure relates to an internal combustion engine.

### 2. Description of Related Art

An internal combustion engine including a port injection valve that injects a fuel into an intake port and an in-cylinder injection valve that directly injects the fuel into a cylinder is known. In such an internal combustion engine, a technique is known in which, in an operation state that is predetermined where a deposit tends to adhere to the back of a head of an intake valve, a part of the fuel injection amount to be supplied to the cylinder every cycle is injected from a port injection valve and the remaining part is injected from an in-cylinder injection valve (see, for example, Japanese Unexamined Patent Application Publication No. 2015-117661 (JP 2015-117661 A)).

In addition, a technique is also known in which, when a deposit adhered to the back of a head of an intake valve needs to be cleaned, fuel injection from an in-cylinder injection valve is stopped and fuel injection from a port injection valve is performed (see, for example, Japanese Unexamined Patent Application Publication No. 2007-247425 (JP 2007-247425 A)).

In addition, a technique is known in which, in a case where the estimated amount of deposit accumulated on the in-cylinder injection valve is greater than an amount that is predetermined when fuel injection from the port injection valve is performed in an idle operation state, the fuel injection from the port injection valve is stopped and fuel injection from the in-cylinder injection valve is performed (see, for example, Japanese Unexamined Patent Application Publication No. 2012-149555 (JP 2012-149555 A)).

### SUMMARY

An object of the present disclosure is to provide an effective technique for suppressing excessive accumulation of a deposit derived from a fuel in an intake port of an internal combustion engine.

An aspect of the present disclosure is an internal combustion engine. For example, the internal combustion engine in the case includes

a first injection valve configured to inject a fuel into an intake port of the internal combustion engine,

a second injection valve configured to inject a fuel into a cylinder of the internal combustion engine, and

a controller configured to control an in-cylinder injection ratio that is a ratio of an in-cylinder injection amount to a total amount of a port injection amount and the in-cylinder injection amount. The port injection amount is a fuel injection amount of the first injection valve and the in-cylinder injection amount is a fuel injection amount of the second injection valve.

The controller is configured to execute

detecting accumulation of a deposit in the intake port; and setting the in-cylinder injection ratio in an operation region that is predetermined to 100% in accordance with the detection of the accumulation of the deposit in the intake port.

According to the present disclosure, it is possible to provide an effective technique for suppressing excessive accumulation of a deposit derived from a fuel in an intake port of an internal combustion engine.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing an example of a schematic configuration of a vehicle according to an embodiment;

FIG. 2 is a diagram schematically showing an example of a distribution map according to the embodiment;

FIG. 3 is a flowchart showing an example of a processing routine executed by an ECU in deposit accumulation detection processing of the embodiment; and

FIG. 4 is a flowchart showing an example of a processing routine executed by the ECU in deposit accumulation suppression processing of the embodiment.

### DETAILED DESCRIPTION OF EMBODIMENTS

In an internal combustion engine including a first injection valve that injects a fuel into an intake port and a second injection valve that injects the fuel into a cylinder, when operation is performed in a low-load low-speed operation region (for example, an idle operation region) in which an in-cylinder injection ratio (a ratio (percentage) of an in-cylinder injection amount to a total amount of a port injection amount and the in-cylinder injection amount, the port injection amount being a fuel injection amount of the first injection valve and the in-cylinder injection amount being a fuel injection amount of the second injection valve) is 0%, a part of the fuel injected from the first injection valve may be blown back from the cylinder into the intake port and adhere to an intake port wall surface. Regarding such a phenomenon, it was found that, when a time during which the internal combustion engine is operated in an operation state where the in-cylinder injection ratio is 0% is long, a deposit derived from a fuel (hereinafter, may be referred to as an "adhesive fuel") adhering to a portion may be generated and accumulated on the intake port wall surface. In addition, it was also found that a failure in closing the intake valve may occur due to peeling of the accumulated deposit from the intake port wall surface. Therefore, there is a demand for a measure for suppressing the excessive increase in the accumulation amount of the deposit on the intake port wall surface.

An internal combustion engine according to the present disclosure includes a controller configured to set an in-cylinder injection ratio in an operation region that is predetermined to 100% in accordance with detection of accumulation of a deposit in an intake port. The "operation region that is predetermined" according to the present disclosure may be, for example, a low-load low-speed operation region or the like, which is an operation region in which the in-cylinder injection ratio at a time of normal operation (when the accumulation of the deposit in the intake port is not detected) is set to 0%. In another example, the "operation region that is predetermined" may be an operation region in which the in-cylinder injection ratio at a time of normal operation is set to less than 100% (an operation region in which a port injection ratio (a ratio (percentage) of a port injection amount to a total amount of the port injection amount and an in-cylinder injection amount) is set to a ratio greater than 0%). In this case, the in-cylinder injection ratio is set to 100% (the port injection ratio is set to 0%) in all the operation regions of the internal combustion engine.

With the internal combustion engine according to the present disclosure, it is possible to suppress the excessive increase in the accumulation amount of the deposit derived from the fuel injected from the first injection valve on the intake port and the back surface of the head portion of the intake valve.

Here, in the internal combustion engine according to the present disclosure, the detection of the accumulation of the deposit in the intake port may include determining that the deposit is accumulated in the intake port in accordance with the detection of the consecutive misfires at the time of the start of the internal combustion engine, the detection of the compression loss at the time of the start of the internal combustion engine, or the time length from the fuel injection timing of the first injection valve until the occurrence of the rich deviation of the air-fuel ratio being equal to or longer than a threshold that is predetermined. In addition, in the internal combustion engine according to the present disclosure, the operation region that is predetermined may include at least a low-load low-speed operation region.

Hereinafter, specific embodiments of the present disclosure will be described with reference to the drawings. Unless otherwise specified, the hardware configuration, module configuration, functional configuration, and the like described in the following embodiment are not intended to limit the technical scope of the disclosure.

### Embodiment

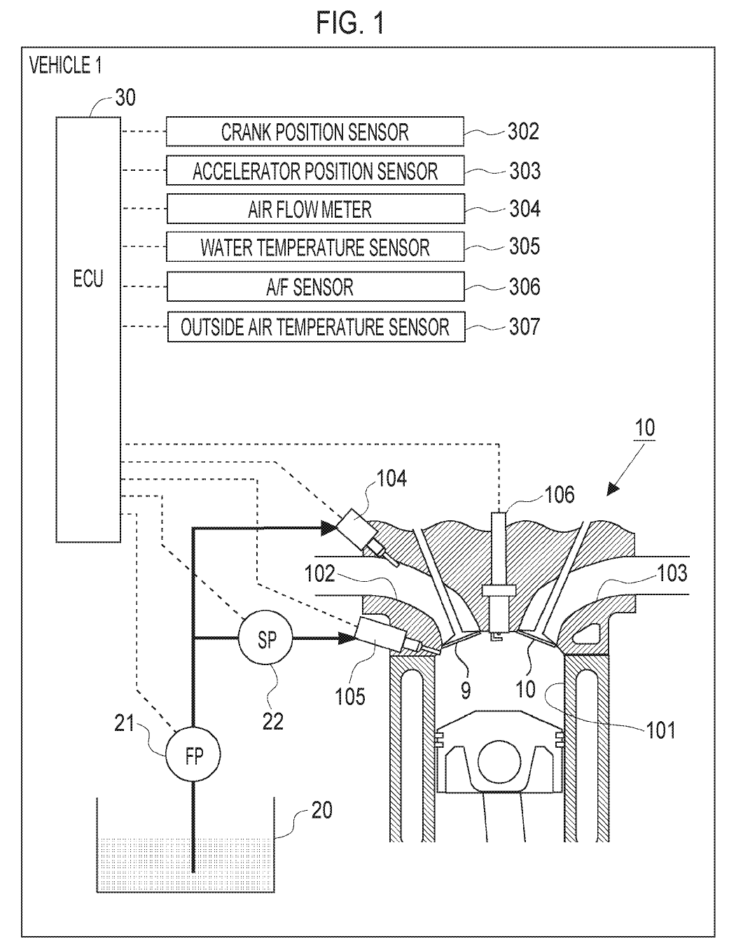

FIG. 1 is a diagram showing an example of a schematic configuration of a vehicle 1 to which the present disclosure is applied. The vehicle 1 shown in FIG. 1 is an automobile equipped with an internal combustion engine 10. The vehicle 1 may be an internal combustion engine vehicle using the internal combustion engine 10 as a power source, or a hybrid electric vehicle (HEV) or a plug-in hybrid electric vehicle (PHEV) using a hybrid system of the internal combustion engine 10 and an electric motor as a power source. The vehicle 1 may be a battery electric vehicle (BEV) using an electric motor that operates using power generated by the internal combustion engine 10 as a power source.

The internal combustion engine 10 is a spark-ignition type four-cycle engine (gasoline engine) that includes one or more cylinders 101 and uses gasoline as a fuel. The internal combustion engine 10 according to the present embodiment is configured to include an intake port 102, an exhaust port 103, a port injection valve 104, an in-cylinder injection valve 105, an ignition plug 106, an intake valve 107, and an exhaust valve 108. The intake port 102 is a passage through which air inhaled into the cylinder 101 flows. The exhaust port 103 is a passage through which a burnt gas discharged from the inside of the cylinder 101 flows. The port injection valve 104 is a fuel injection valve (injector) that injects a fuel into the intake port 102. The in-cylinder injection valve 105 is a fuel injection valve (injector) that injects the fuel into the cylinder 101. The ignition plug 106 is a component for igniting an air-fuel mixture generated inside the cylinder 101. The intake valve 107 is a poppet valve that opens and closes an opening end of the intake port 102 on a downstream side. The exhaust valve 108 is a poppet valve that opens and closes an opening end of the exhaust port 103 on an upstream side. In the present embodiment, the port injection valve 104 corresponds to a “first injection valve” according to the present disclosure, and the in-cylinder injection valve 105 corresponds to a “second injection valve” according to the present disclosure.

In addition, in the vehicle 1 according to the present embodiment, a fuel tank 20, a feed pump 21 (“FP” in FIG. 1), and a supply pump 22 (“SP” in FIG. 1) are mounted. The fuel tank 20 is a tank that stores gasoline, which is a fuel of the internal combustion engine 10. The feed pump 21 is a pump that lifts a fuel stored in the fuel tank 20 and sends the lifted fuel to each of the port injection valve 104 and the supply pump 22. The supply pump 22 is a pump that pressurizes the fuel sent from the feed pump 21 and that sends the pressurized fuel to the in-cylinder injection valve 105. In addition, an electronic control unit (ECU) 30 for electrically controlling the internal combustion engine 10 and peripheral devices thereof is mounted in the vehicle 1 according to the present embodiment. The ECU 30 is a computer including a CPU, a ROM, a RAM, and an auxiliary storage device. In the ECU 30 according to the present embodiment, various sensors, such as a crank position sensor 302, an accelerator position sensor 303, an air flow meter 304, a water temperature sensor 305, an A/F sensor 306, and an outside air temperature sensor 307, are connected in addition to the fuel remaining amount sensor 301, and signals thereof are input to the ECU 30. The crank position sensor 302 is a sensor that detects a rotational position of an output shaft (crankshaft) of the internal combustion engine 10. The accelerator position sensor 303 is a sensor that detects an operation amount of an accelerator pedal. The air flow meter 304 is a sensor that detects an inhaled air amount of the internal combustion engine 10. The water temperature sensor 305 is a sensor that detects a temperature of cooling water (coolant) circulating the internal combustion engine 10. The A/F sensor 306 is a sensor that detects an air-fuel ratio (A/F) of an air-fuel mixture supplied for combustion in the cylinder 101 according to the oxygen concentration in the exhaust gas of the internal combustion engine 10. The outside air temperature sensor 307 is a sensor that detects a temperature outside the vehicle.

In addition, the ECU 30 is electrically connected to the devices such as the port injection valve 104, the in-cylinder injection valve 105, the ignition plug 106, the feed pump 21, and the supply pump 22. The ECU 30 is configured to control the port injection valve 104, the in-cylinder injection valve 105, the ignition plug 106, the feed pump 21, the supply pump 22, and the like according to signals input from the sensors.

For example, the ECU 30 determines a fuel injection amount per cycle of each of the port injection valve 104 and the in-cylinder injection valve 105 according to an operation state of the internal combustion engine 10. Specifically, the ECU 30 first calculates an engine rotation speed Ne and an engine load rate KL for each cycle of the internal combustion engine 10. The engine rotation speed Ne described herein is a rotation speed of a crankshaft per unit time and is calculated according to a signal of the crank position sensor 302. The engine load rate KL is a ratio of a current inhaled air amount to a maximum value (an inhaled air amount at a full load) of the inhaled air amount corresponding to each engine rotation speed Ne, and is calculated according to a signal (inhaled air amount) of the air flow meter 304 and the engine rotation speed Ne.

The ECU 30 calculates an in-cylinder injection ratio (percentage) according to the calculated engine rotation speed Ne and engine load rate KL. The in-cylinder injection ratio described herein refers to a total fuel injection amount (a total amount of a fuel amount injected from the port injection valve 104 (port injection amount) and a fuel amount injected from the in-cylinder injection valve 105 (in-cylinder injection amount)) per cycle for each cylinder 101. For example, the ECU 30 calculates the in-cylinder injection ratio using a distribution map in which the engine rotation speed Ne and the engine load rate KL are used as parameters. The distribution map is stored in the ROM or the auxiliary storage device of the ECU 30 in advance. In the case, the ROM or the auxiliary storage device of the ECU 30 stores a plurality of distribution maps corresponding to a cooling water temperature, an outside air temperature, and the like.

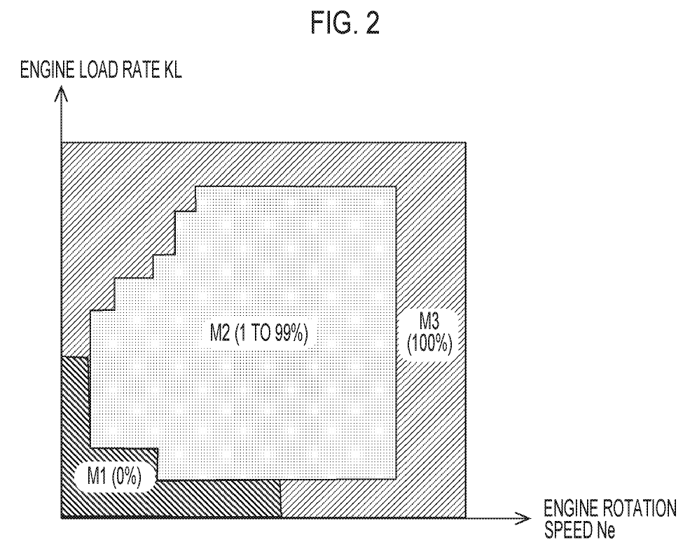

Here, FIG. 2 shows an example of the distribution map. The distribution map shown in FIG. 2 is a map for setting the in-cylinder injection ratio after completion of warming up of the internal combustion engine 10. In the example shown in FIG. 2, in a low-load low-speed operation region (region M1 in FIG. 2) where the engine rotation speed Ne and the engine load rate KL are relatively low, the in-cylinder injection ratio is set to 0%. In addition, in one or both of a high-speed operation region where the engine rotation speed Ne is relatively high and a high-load operation region (region M3 in FIG. 2) where the engine load rate KL is relatively high, the in-cylinder injection ratio is set to 100%. Furthermore, in a medium-load medium-speed operation region (region M2 in FIG. 2) other than the regions M1 and M3, the in-cylinder injection ratio is set according to the engine rotation speed Ne and the engine load rate KL within a range of 1% to 99%.

The ECU 30 calculates the in-cylinder injection amount and the port injection amount according to the in-cylinder injection ratio and the total fuel injection amount. That is, the ECU 30 calculates the in-cylinder injection amount by multiplying the total fuel injection amount by the in-cylinder injection ratio. The total fuel injection amount per cycle for each cylinder 101 may be, for example, calculated according to a signal (inhaled air amount) of the air flow meter 304 and a target air-fuel ratio (for example, a stoichiometric air-fuel ratio). In addition, the ECU 30 calculates the port injection amount by subtracting the in-cylinder injection ratio from the total fuel injection amount. The port injection amount may be calculated by calculating a port injection ratio from the in-cylinder injection ratio (100% – in-cylinder injection ratio) and multiplying the total fuel injection amount by the calculated port injection ratio.

The ECU 30 controls the supply pump 22 and the in-cylinder injection valve 105 according to the calculated in-cylinder injection amount, and controls the port injection valve 104 according to the calculated port injection amount. Accordingly, the fuel can be injected from each of the port injection valve 104 and the in-cylinder injection valve 105 at the in-cylinder injection ratio suitable for the operation state of the internal combustion engine 10.

In addition, the ECU 30 according to the present embodiment also has a function of executing the deposit accumulation detection processing. The deposit accumulation detection processing is processing for detecting the accumulation of the deposit in the intake port 102. Further, the ECU 30 according to the present embodiment also has a function of executing the deposit accumulation suppression processing in accordance with the detection of the accumulation of the deposit in the intake port 102. The deposit accumulation suppression processing is processing for suppressing an increase in the deposit accumulation amount in the intake port 102. The ECU 30 having the functions corresponds to a "controller" according to the present disclosure.

### Deposit Accumulation Detection Processing

Here, the deposit accumulation detection processing according to the present embodiment will be described. When the internal combustion engine 10 is operated in a state where a certain amount or more of the deposit is accumulated on the wall surface of the intake port 102, a part of the deposit may be peeled off from the wall surface of the intake port 102 during the cranking of the internal combustion engine 10 and may cause the failure in closing the intake valve 107. As a result, the compression loss in which the compression pressure of the cylinder 101 is reduced occurs, and accordingly, the consecutive misfires (a phenomenon in which the misfire occurs consecutively for two cycles or more) occur in the cylinder 101. Such a compression loss and consecutive misfires are likely to occur during the cranking at the time of a cold start. Therefore, in the deposit accumulation detection processing according to the present embodiment, the ECU 30 is configured to determine whether the consecutive misfires have occurred in each of the cylinders 101 during the cranking of the internal combustion engine 10.

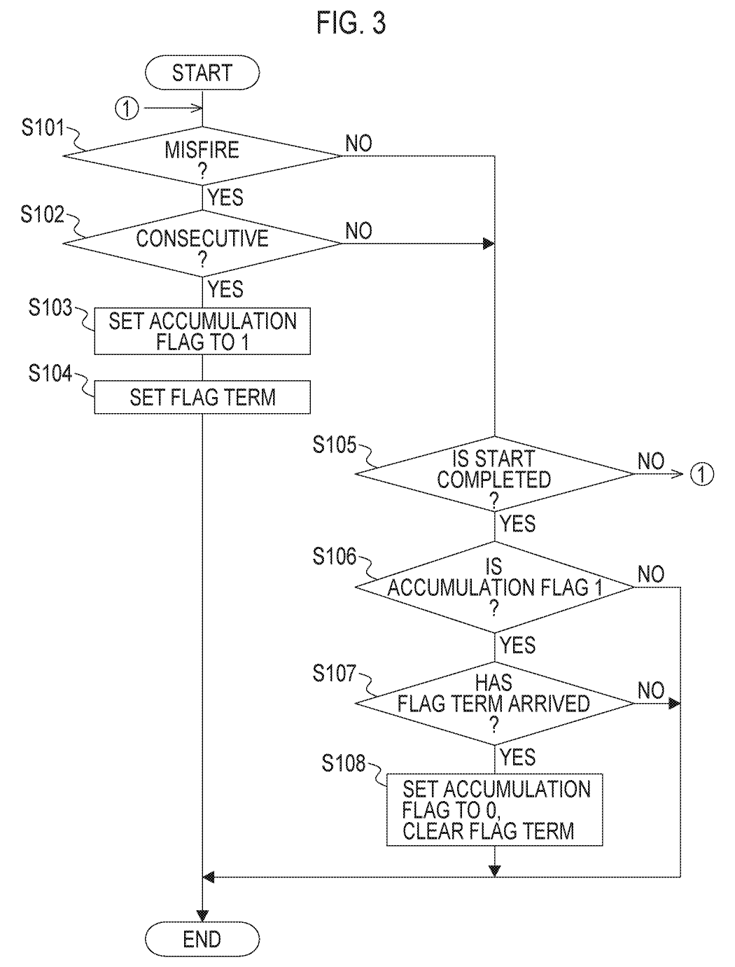

FIG. 3 is a flowchart showing an example of a processing routine executed by the ECU 30 in the deposit accumulation detection processing of the present embodiment. The processing routine shown in FIG. 3 is executed in response to a trigger that the cranking of the internal combustion engine 10 is started.

In FIG. 3, the ECU 30 determines whether the misfire has occurred in any of the cylinders 101 of the internal combustion engine 10 (S101). The misfire determination method is not particularly limited, and a well-known method may be used. As an example, the ECU 30 may determine whether the misfire has occurred in each of the cylinders 101 according to the angular velocity of the crankshaft during the cranking of the internal combustion engine 10. For example, when the misfire occurs in the first cylinder 101, the angular velocity immediately after the ignition (for example, in the expansion stroke) of the first cylinder 101 is significantly lower than the angular velocity immediately after the ignition of the second cylinder 101 in which the ignition was performed immediately before the first cylinder 101. Therefore, the ECU 30 may determine that the misfire has occurred in the first cylinder 101 when the angular velocity immediately after the ignition of the first cylinder 101 is smaller by a certain value or more as compared with the angular velocity immediately after the ignition of the second cylinder 101. In a case where it is determined that the misfire has occurred in any of the cylinders 101 of the internal combustion engine 10 (positive determination in S101), the ECU 30 executes the processing of S102.

In S102, the ECU 30 determines whether the misfire has occurred in the cylinder 101 (hereinafter, may be referred to as "target cylinder 101") determined that the misfire has occurred in S101 in the previous cycle. That is, the ECU 30 determines whether the consecutive misfires have occurred in the target cylinder 101. In order to perform such a determination, the ECU 30 may store identification information (for example, a cylinder ID) of the cylinder 101 determined that the misfire has occurred in the previous cycle in the auxiliary storage device. The ECU 30 may collate the cylinder ID of the target cylinder 101 with the cylinder ID stored in the auxiliary storage device, and determine that the consecutive misfires have occurred in the target cylinder 101 in accordance with the successful collation. In a case where it is determined that the consecutive misfires have occurred in the target cylinder 101 (positive determination in S102), the ECU 30 determines that a certain amount or more of the deposit is accumulated on the wall surface of the intake port 102 of the target cylinder 101, and executes the processing of S103.

In S103, the ECU 30 sets the value of the accumulation flag to "1". The accumulation flag is a storage region assigned to the auxiliary storage device of the ECU 30, and "1" is stored when it is determined that a certain amount or more of the deposit is accumulated on the wall surface of the intake port 102 of any of the cylinders 101 of the internal combustion engine 10. An initial value of the accumulation flag is "0". When the processing of S103 is completed, the ECU 30 executes the processing of S104.

In S104, the ECU 30 stores a flag term that is a validity period of the accumulation flag set in S103 in the auxiliary storage device. The flag term is an end point of a period needed for the certain amount or more of the deposit accumulated on the wall surface of the intake port 102 to be removed (or to be reduced to an amount sufficiently less than the certain amount). In one example, the flag term may be a date and time several years (for example, about 1 year to 2 years) after the point in time when "1" is set in the accumulation flag. The period needed for the certain amount or more of the deposit accumulated on the wall surface of the intake port 102 to be removed (or to be reduced to an amount sufficiently less than the certain amount) may be obtained in advance by one or both of an experiment and a simulation, and the flag term may be determined according to the obtained period. The flag term determined as described above may be stored in the auxiliary storage device in a form associated with the accumulation flag. Note that the consecutive misfires may occur in a state where the flag term is already set. In this case, the flag term stored in the auxiliary storage device may be the already set flag term or may be updated (rewritten) to a new flag term. When the processing of S104 is completed, the ECU 30 ends the execution of the processing routine in FIG. 3.

In addition, in a case where it is determined that the misfire has not occurred in any of the cylinders 101 of the internal combustion engine 10 in S101 (negative determination in S101), and it is determined that the consecutive misfires have not occurred in the target cylinder 101 in S102 (negative determination in S102), the ECU 30 executes the processing of S105.

In S105, the ECU 30 determines whether the start of the internal combustion engine 10 is completed. As a method of determining whether the start of the internal combustion engine 10 is completed, various well-known methods can be used. As an example, the ECU 30 may determine that the start of the internal combustion engine 10 is completed in accordance with the engine rotation speed Ne increasing to equal to or greater than a threshold that is predetermined. In a case where it is determined that the start of the internal combustion engine 10 is not completed (negative determination in S105), the ECU 30 executes the processing of S101 again. On the other hand, in a case where it is determined that the start of the internal combustion engine 10 is completed (positive determination in S105), the ECU 30 executes the processing of S106.

In S106, the ECU 30 determines whether the value of the accumulation flag stored in the auxiliary storage device is "1". When the value of the accumulation flag is "1" (positive determination in S106), the ECU 30 executes the processing of S107.

In S107, the ECU 30 determines whether the flag term stored in the auxiliary storage device has arrived. When the flag term has arrived (positive determination in S107), the ECU 30 executes the processing of S108.

In S108, the ECU 30 resets the value of the accumulation flag and the flag term stored in the auxiliary storage device. Specifically, the ECU 30 resets the value of the accumulation flag from "1" to "0" and clears (deletes) the flag term. As described above, in the present embodiment, when the consecutive misfires do not occur in a period from when the value of the accumulation flag is set to "1" until the flag term arrives, the accumulation flag and the flag term are reset. When the processing of S108 is completed, the ECU 30 ends the execution of the processing routine in FIG. 3.

In addition, in a case where it is determined that the value of the accumulation flag in S106 is not "1" (accumulation flag = "0") (negative determination in S106), and it is determined that the flag term in S107 has not yet arrived (negative determination in S107), the ECU 30 ends the execution of the processing routine in FIG. 3.

### Deposit Accumulation Suppression Processing

Next, the deposit accumulation suppression processing according to the present embodiment will be described. The deposit accumulation suppression processing of the present embodiment is processing for suppressing the generation and accumulation of the deposit on the wall surface of the intake port 102 of the target cylinder 101 until the certain amount or more of the deposit accumulated on the wall surface of the intake port 102 of the target cylinder 101 is removed (or is reduced to an amount sufficiently less than the certain amount). In one example, the deposit accumulation suppression processing may be processing of setting the in-cylinder injection ratio of the operation region that is predetermined to 100% in a period in which "1" is set in the accumulation flag (a period until the flag term arrives). The operation region that is predetermined is an operation region in which the in-cylinder injection ratio is less than 100% (the port injection ratio is greater than 0%), and is an operation region in which the deposit derived from the fuel injected from the port injection valve 104 is likely to be accumulated on the wall surface of the intake port 102. In one example, the operation region that is predetermined may be an operation region in which the engine load rate KL and the engine rotation speed Ne are low, as in the region M1 in FIG. 2, and the in-cylinder injection ratio is set to 0%. In another example, the operation region that is predetermined may include a region M2 in addition to the region M1 in FIG. 2. That is, the operation region that is predetermined may be an operation region in which the in-cylinder injection ratio is set to less than 100% (the port injection ratio is greater than 0%).

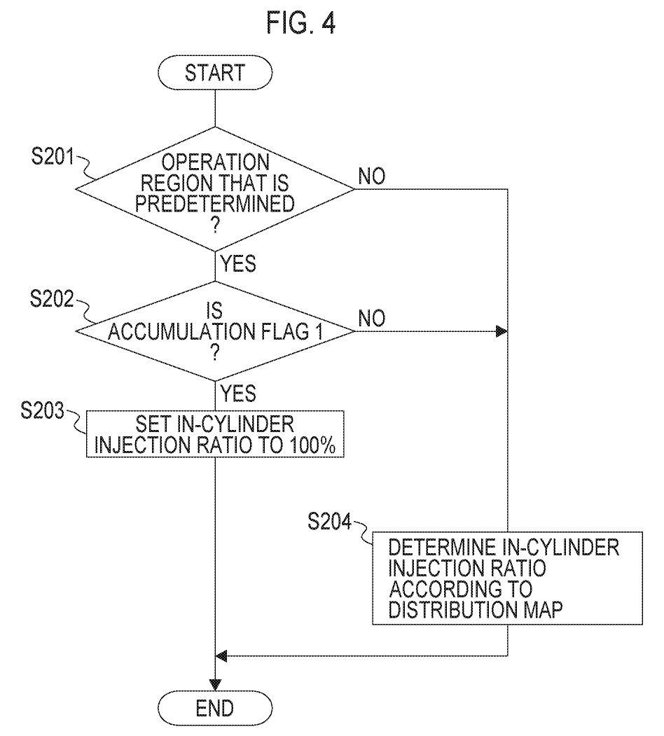

FIG. 4 is a flowchart showing an example of a processing routine executed by the ECU 30 in the deposit accumulation suppression processing of the present embodiment. The processing routine shown in FIG. 4 is repeatedly executed during the operation of the internal combustion engine 10 at an interval that is predetermined (for example, for each cycle).

In FIG. 4, the ECU 30 determines whether the current operation state of the internal combustion engine 10 belongs to the operation region that is predetermined (S201). The operation region that is predetermined is, as described above, the region M1 (or an operation region obtained by combining the region M1 and the region M2) in FIG. 2. In the determination, first, the ECU 30 calculates the engine rotation speed Ne and the engine load rate KL according to the signals of the crank position sensor 302 and the air flow meter 304. Subsequently, the ECU 30 determines whether the operation state specified by the calculated engine rotation speed Ne and the engine load rate KL belongs to the region M1 (or the operation region obtained by combining the region M1 and the region M2) by accessing the distribution map in FIG. 2 using the calculated engine rotation speed Ne and the engine load rate KL as parameters. In a case where it is determined that the operation state of the internal combustion engine 10 belongs to the operation region that is predetermined (positive determination in S201), the ECU 30 executes the processing of S202.

In S202, the ECU 30 determines whether the value of the accumulation flag stored in the auxiliary storage device is "1". When the value of the accumulation flag stored in the auxiliary storage device is "1" (positive determination in S202), the ECU 30 executes the processing of S203.

In S203, the ECU 30 sets the in-cylinder injection ratio to 100% (the port injection ratio to 0%). In this case, in the operation region that is predetermined, the entire amount of the total fuel injection amount is injected from the in-cylinder injection valve 105. That is, in the operation region that is predetermined, the fuel is not injected from the port injection valve 104. As a result, the deposit derived from the fuel injected from the port injection valve 104 is not generated in the intake port 102, and the increase in the deposit accumulation amount on the wall surface of the intake port 102 is suppressed.

In addition, in a case where it is determined that the operation state of the internal combustion engine 10 does not belong to the operation region that is predetermined in S201 (negative determination in S201), the ECU 30 executes the processing of S204. In S204, the ECU 30 sets the in-cylinder injection ratio according to the distribution map in FIG. 2, and calculates the in-cylinder injection amount and the port injection amount according to the set in-cylinder injection ratio. When the processing of S204 is completed, the ECU 30 ends the execution of the processing routine in FIG. 4.

### Action and Effect of Embodiment

In the present embodiment, when it is determined (estimated) that a certain amount or more of the deposit is accumulated on the wall surface of the intake port 102 of the internal combustion engine 10, the in-cylinder injection ratio in the operation region that is predetermined is set to 100% (the port injection ratio is set to 0%) until the period needed for the certain amount or more of the deposit accumulated on the wall surface of the intake port 102 to be removed (or to be reduced to an amount sufficiently less than the certain amount) elapses. As a result, the deposit derived from the fuel injected from the port injection valve 104 is not generated in the intake port 102. As a result, it is possible to suppress the excessive increase in the deposit accumulation amount on the wall surface of the intake port 102.

### Modification 1

In the deposit accumulation detection processing, the ECU 30 may determine that a certain amount or more of the deposit is accumulated on the wall surface of the intake port 102 in accordance with the detection of the compression loss during the cranking of the internal combustion engine 10. Various well-known methods can be used as a method of detecting the compression loss. In one example, the ECU 30 may determine whether the compression loss occurs according to the angular velocity of the crankshaft when the piston of each cylinder 101 passes through the top dead center of compression.

### Modification 2

In the deposit accumulation detection processing, the ECU 30 may determine that a certain amount or more of the deposit is accumulated on the wall surface of the intake port 102 in accordance with the time length from the fuel injection timing of the port injection valve 104 during the operation of the internal combustion engine 10 until the occurrence of the rich deviation of the air-fuel ratio being equal to or longer than a time length that is predetermined.

Here, a part of the fuel injected from the port injection valve 104 during the operation of the internal combustion engine 10 adheres to the wall surface of the intake port 102. The fuel (adhesive fuel) adhered to the wall surface of the intake port 102 in this way flows into the cylinder 101 in the intake stroke of the next cycle or later. That is, a time delay occurs until the adhesive fuel flows into the cylinder 101. Then, a deviation of the air-fuel ratio to the rich side occurs due to the adhesive fuel flowing into the cylinder 101 with the time delay.

The time delay described above may change according to the deposit accumulation amount on the wall surface of the intake port 102. That is, in a case where a certain amount or more of the deposit is accumulated on the wall surface of the intake port 102, the time delay described above tends to be longer compared to a case where the deposit is not accumulated on the wall surface of the intake port 102 or a case where the deposit accumulated on the wall surface of the intake port 102 is less than the certain amount. With this, in a case where a certain amount or more of the deposit is accumulated on the wall surface of the intake port 102, the time length from the injection timing of the port injection valve 104 until the occurrence of the rich deviation tends to be longer compared to a case where the deposit is not accumulated on the wall surface of the intake port 102 or a case where the deposit accumulated on the wall surface of the intake port 102 is less than the certain amount.

Therefore, when the time length from the fuel injection timing of the port injection valve 104 during the operation of the internal combustion engine 10 until the occurrence of the rich deviation of the air-fuel ratio is equal to or longer than the time length that is predetermined, it is possible to determine (estimate) that a certain amount or more of the deposit is accumulated on the wall surface of the intake port 102.

### Modification 3

In the deposit accumulation detection processing, the ECU 30 may determine that a certain amount or more of the deposit is accumulated on the wall surface of the intake port 102 in accordance with the correction amount of the port injection amount during the operation of the internal combustion engine 10 being equal to or greater than an amount that is predetermined.

Here, in a process of the deposit being accumulated on the wall surface of the intake port 102, there is a possibility that the deposit is also accumulated around the injection hole of the port injection valve 104. In particular, in a case where the fuel having the property of easily generating deposit is used, the deposit is likely to be accumulated on the wall surface of the intake port 102 as well as around the injection hole of the port injection valve 104. When the deposit accumulation amount around the injection hole of the port injection valve 104 increases, there is a possibility that the injection hole is narrowed. In this case, the port injection amount is corrected to an increase side by the air-fuel ratio feedback control based on the signal of the A/F sensor 306. The correction amount in this case is increased as the deposit accumulation amount around the injection hole of the port injection valve 104 is increased. Therefore, when the correction amount of the port injection amount is equal to or greater than an amount that is predetermined, it is possible to estimate that a certain amount or more of the deposit is accumulated on the wall surface of the intake port 102.

### Others

The embodiment and the modifications described above are merely examples, and the present disclosure can be appropriately changed and implemented without departing from the gist thereof. For example, the embodiment and the modifications described above can be implemented in combination with each other without any technical contradiction.

What is claimed is:

1. An internal combustion engine comprising:
a first injection valve configured to inject a fuel into an intake port of the internal combustion engine;
a second injection valve configured to inject a fuel into a cylinder of the internal combustion engine; and
a controller configured to control an in-cylinder injection ratio that is a ratio of an in-cylinder injection amount to a total amount of a port injection amount and the in-cylinder injection amount, the port injection amount being a fuel injection amount of the first injection valve, the in-cylinder injection amount being a fuel injection amount of the second injection valve, wherein:
the controller is configured to execute
detecting accumulation of a deposit in the intake port; and
setting the in-cylinder injection ratio in an operation region that is predetermined to 100% in accordance with the detection of the accumulation of the deposit in the intake port.

2. The internal combustion engine according to claim 1, wherein the detecting the accumulation of the deposit in the intake port includes determining that the deposit is accumulated in the intake port in accordance with detection of consecutive misfires at a time of start of the internal combustion engine.

3. The internal combustion engine according to claim 1, wherein the detecting the accumulation of the deposit in the intake port includes determining that the deposit is accumulated in the intake port in accordance with detection of a compression loss at a time of start of the internal combustion engine.

4. The internal combustion engine according to claim 1, wherein the detecting the accumulation of the deposit in the intake port includes determining that the deposit is accumulated in the intake port in accordance with a time length from fuel injection timing of the first injection valve until occurrence of a rich deviation of an air-fuel ratio being equal to or longer than a threshold that is predetermined.

5. The internal combustion engine according to claim 1, wherein the operation region that is predetermined includes at least a low-load low-speed operation region.
